(19) United States
(12) Patent Application Publication
(10) Pub. No.: US 2008/0300513 A1
(43) Pub. Date: Dec. 4, 2008

(54) TOE MASSAGER

(76) Inventor: Terry Chouinard, Santa Monica, CA (US)

Correspondence Address: JACKSON & CO., LLP, 6114 LA SALLE AVENUE, #507, OAKLAND, CA, 94611-2802, US

(21) Appl. No.: 11/757,307

(22) Filed: Jun. 1, 2007

(51) Int. Cl. A61H 1/00; A45D 29/00; A61H 15/00

(52) U.S. Cl. 601/27; 132/73; 601/125

(57) ABSTRACT

In particular embodiments, a toe massager including an elongated body having a first end and a second end, the elongated body including an outer material and an inner material, wherein the elongated body is positionable between a plurality of toes such that each of the plurality of toes are spaced apart from each other is provided.

### TECHNICAL FIELD

The present disclosure relates generally to toe massager and/or nail accessory.

### BACKGROUND

Massage devices and implements typically are designed for a specific part of the body. For example, there exists massage chairs, foot massagers, and handheld electronic massage devices that impart pressure or force upon the desired part of the body to provide therapeutic effect on the muscles such as back, foot, and the like. These types of electronic massage devices are generally costly and require power supply to operate.

In view of the foregoing, it would be desirable to have a cost effective massager that is compact and simple to use without the need for a power supply. More specifically, it would be desirable to have a toe massager that allows massage energy to freely be dispersed between the toes using natural forces of material composition.

### SUMMARY

### Overview

A toe massager in one embodiment of the present invention includes an elongated body having a first end and a second end, the elongated body including an outer material and an inner material, where the elongated body is positionable between a plurality of toes such that each of the plurality of toes are spaced apart from each other.

These and other features and advantages of the present disclosure will be understood upon consideration of the following description of the particular embodiments and the accompanying drawings.

### BRIEF DESCRIPTION OF THE DRAWINGS

FIG. 1 is an overall view of the toe massager in one embodiment of the present disclosure;

FIG. 2 illustrates the toe massager of FIG. 1 with the inner material exposed and the outer layer substantially removed in one embodiment of the present disclosure;

FIG. 3 is a perspective view of one end of the toe massager with the inner material exposed in one embodiment of the present disclosure;

FIG. 4 is a cross sectional view of the toe massager of FIG. 1 in one embodiment of the present disclosure;

FIG. 5 illustrates a close up view of the first end segment of the toe massager of FIG. 1 in one embodiment of the present disclosure; and

FIG. 6 illustrates the toe massager applied to a foot to separate the toes in one aspect of the present disclosure.

### DETAILED DESCRIPTION

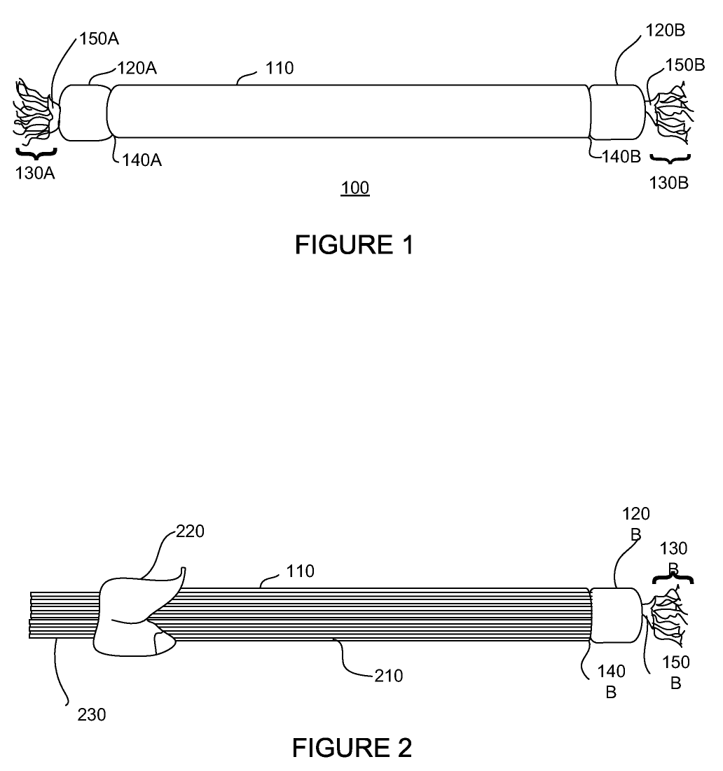

FIG. 1 is an overall view of the toe massager in one embodiment of the present disclosure. Referring to FIG. 1, in one embodiment, toe massager 100 includes a body section 110 with a first end segment 120A and a second end segment 120B. The first end segment 120A also includes a first frayed section 130A, and the second end segment 120B includes a second frayed section 130B. As shown in FIG. 1, the body section 110, the first and second end segment 120A, 120B, and the first and second frayed section 130A, 130B are provided as an elongated and continuous toe massager 100. In one aspect, the first and second frayed sections 130A, 130B are optional aspects of toe massager 100, and accordingly, within the scope of the present disclosure, one or more of the first and second frayed sections 130A, 130B may be replaced with other features or configuration such as, for example, but not limited to, one or more beads, balls, rounded ends, or other suitable patterns or configuration.

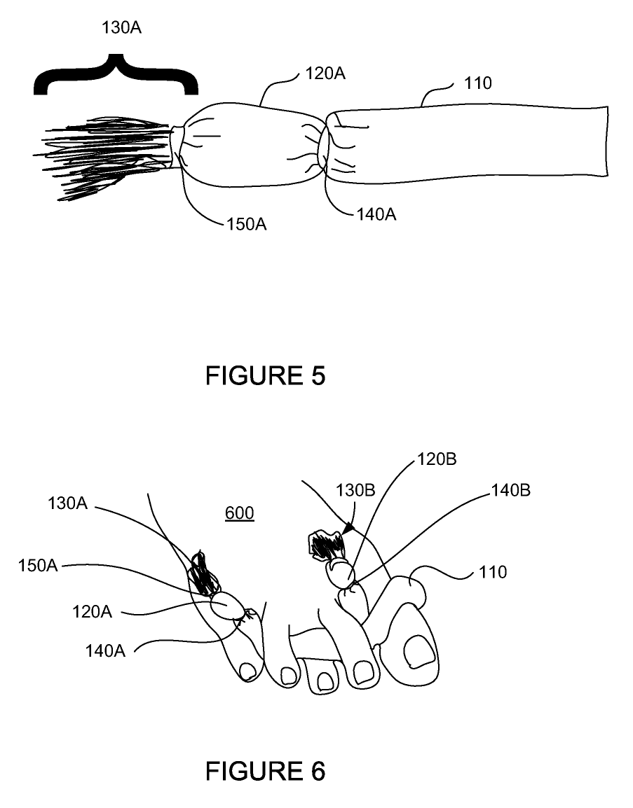

Furthermore, as also shown in FIG. 1, the body section 110 and each of the first end segment 120A, and the second end segment 120B are separated by a respective tie 140A, 140B, which in one embodiment, may be a threaded tie or a crimp (for example, by threads or a metal or plastic crimp) to provide separation of the body section 110 from each of the first end segment 120A and the second end segment 120B. Additionally, further respective tie ends 150A, 150B are provided to separate the first end segment 120A from the first frayed section 130A, and to separate the second end segment 130A from the second frayed section 130B. In this manner, in one aspect of the present disclosure, the length of the body section 110 of the toe massager 100 may be maintained, as well as the lengths of the first and second segments 120A, 120B. A close up view of the body section 100 and the first end segment 120A, as well as the first frayed section 130A, with the first tie 140A and the tie end 150A are shown in FIG. 5. As can be seem from the Figure, the first tie 140A and the tie end 150A in one aspect provide a distinct separation of the body section 110 from the first end segment 120A, and further, a separation of the first end segment 120A from the first frayed section 130A.

In one embodiment, the length of the toe massager 100 is proportional to the width of the user's foot, such that the toe massager 100 is sufficiently long to be threaded between the toes of the user. In such embodiment, the length of the toe massager 100 may be between approximately 2-3 times the width of the user's foot. In an exemplary embodiment, toe massager 100 may be approximately 11.4 inches, with the body section 110 having a length of approximately 9.5 inches, the first end segment 120A and the second end segment 120B each having a length of approximately 0.5 inches, and each of the first frayed section 130A and the second frayed section 130B having a length of approximately 0.5 inches.

Furthermore, as described in further detail below, the toe massager 100 in one embodiment includes an inner layer or material that comprises approximately 30 threads of natural cotton, with each thread being approximately 0.0166 inches in thickness. Moreover, in one embodiment, the cross-sectional diameter of the toe massager 100, for example, in the body section 110 is approximately 0.5 inches, while the circumference of the body section 100 is approximately 1.5 inches.

It is to be noted that while specific dimensions are provided above, within the scope of the present disclosure, other suitable widths, lengths, circumference, and/or diameter of the various portions or sections of the toe massager 100 may be contemplated. For example, the total length of the toe massager 100 may be less than 11.5 inches suitable for smaller feet and/or toes, or greater than 11.5 inches for larger feet and/or toes. In addition, to achieve a greater separation or to impart a different amount of pressure points stimulation, the diameter or the circumference of the toe massager 100 may be varied.

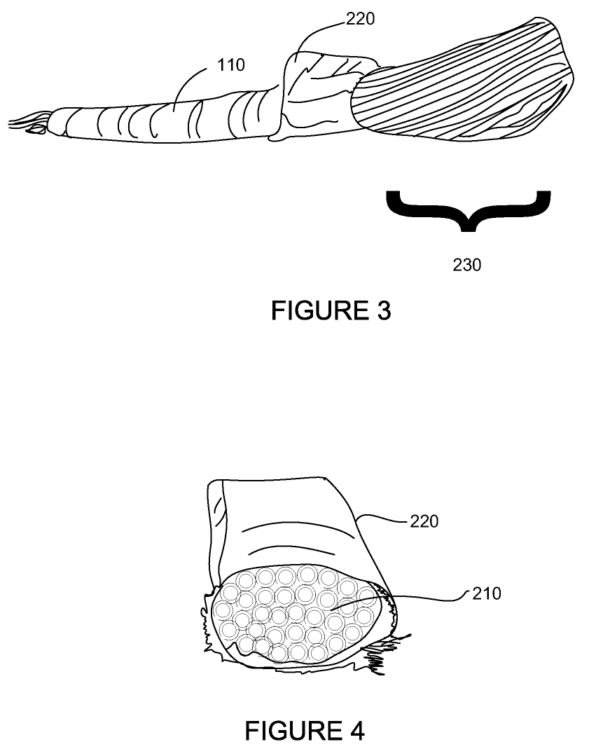

FIG. 2 illustrates the toe massager 100 of FIG. 1 with the inner material exposed and the outer layer substantially removed, while FIG. 3 shows a perspective view of the one end of the toe massager 100 with the inner material exposed. Additionally, FIG. 4 shows a cross sectional view of the toe massager 100 illustrating the inner material and the outer material in one aspect of the present disclosure. Indeed, referring to the Figures, in one embodiment, the toe massager 100 may include an inner material 210 such as, for example, natural cotton threads, and an outer material 220 as shown that comprises, for example, satin or any other suitable material.

While satin and cotton threads are described herein for the outer and inner materials 220, 210 respectively, of the toe massager 100, within the scope of the present disclosure any suitable material may be used for one or more of the inner material 210 or the outer material 220. For example, polyester, nylon, silk, cotton, fiber, one or more combinations thereof, or other suitable fabric or material which may be formed by one or more of weaving, knitting, crocheting, knotting or pressing, and the like, may be used as one or more of the inner material 210 and/or the outer material 220.

Referring again to FIGS. 2-3, also shown is the exposed end section 230 of the inner material 210 illustrating the threads comprising the inner material 210. As discussed above, in one embodiment, the inner material 210 may include approximately thirty 100% natural cotton threads, and which are substantially surrounded and enclosed by the outer material 220 that is made of satin material.

FIG. 6 illustrates the toe massager applied to a foot to separate the toes in one aspect of the present disclosure. Referring to FIG. 6, as can be seen, in one aspect, the toe massager 100 may be positioned in a substantially interleaved matter between the toes of foot 600, such that, for example, the second and the fourth toes are raised, while the first, third and the fifth toes are lowered relative to the second and the fourth toes. As can be further seen from FIG. 6, in toe massager 100 may be configured in one embodiment such that the body section 110 of the toe massager 100 is provided or positioned between the toes, while the ends of the toe massager 100 including the first and second end segments 120A, 120B, and the first and second frayed sections 130A, 130B are positioned so as to be away from the space between the toes.

In this manner, the body portion 110 in one embodiment is configured to separate the toes in an up and down manner as well as sideways. Furthermore, the first and second end segments 120A, 120B in one embodiment are configured to allow pulling or tugging at the toe separator 100 substantially in a direction away from the body section 110 so as to retain the toe separator 100 tightly between the toes once positioned.

Accordingly, in one aspect of the present disclosure, the toe massager 100 is configured to massage and/or stimulate the muscles and ligaments of the toes and the foot by separating the toes in an up and down manner as well as sideways. By separating the toes in this manner, the muscles and ligaments on opposite sides of the foot (for example, upper surface of the foot and the sole of the foot) are pulled and contracted. As such, the continuous or periodic pulling and contracting movements provided by the toe massager 100 in one embodiment is configured to massage and/or stimulate the muscles and ligaments of the foot and the toes. Indeed, in one aspect, the configuration of the toe massager 100 as described above, the interweaving positioning between the toes, and the natural fiber composition of the toe separator 100, individually or in combination provide for dispersion of the stimulation between the toes.

In this manner, in one embodiment of the present disclosure, the toe massager may be configured to gently separate the toes, providing stimulating pressure points on the contact points on the respective toes, and thus provide relaxation of the toes, the foot as well as the whole body. More specifically, in one aspect, the toe massager may be configured to separate the toes substantially in a vertical direction as well as in horizontal direction, to pull and contract the respective muscles, tendons, and ligaments in the foot. Such continuous stimulation by the toe massager in one embodiment provides improved blood circulation and/or relieves tension in the foot.

That is, in one aspect, the toe massager may be configured to stimulate pressure points and/or the nerve endings on the foot, and based on principles of reflexology, the stimulated pressure points and/or the nerve endings on the foot correspond to a respective organ, gland and/or muscle in the body to provide relaxation by for example, reducing tension, and improving blood circulation in the body.

In a further aspect of the present disclosure, the toe massager may be configured to assist during cosmetic treatment of the toes, such as during the application of nail polish, for example. That is, in one aspect, the toe massage may provide sufficient separation of the toes during the application of the nail polish and also, during the drying time of the applied nail polish, such that, the user may be mobile and walk around comfortably with the toe massager in place while the nail polish is drying.

Accordingly, the toe massager in one embodiment of the present disclosure is configured to be comfortably worn for any give time period and including during sleep, rest, and ambulatory time periods including walking, for example, while continuing to providing the gentle separation of the toes and stimulating the pressure points on the foot.

A toe massager in one embodiment includes an elongated body having a first end and a second end, the elongated body including an outer material and an inner material, where the elongated body is positionable between a plurality of toes such that each of the plurality of toes are spaced apart from each other.

The outer material of the elongated body may include satin, and further where the inner material of the elongated body includes cotton.

The elongated body may have a length of approximately 11.5 inches, and further, where the elongated body may have a cross sectional diameter of approximately 0.5 inches.

The toe massager may include a first end segment at the first end of the elongated body and a second end segment at the second end of the elongated body, where the first end segment and the first end of the elongated body may be separated by a first tie, and further, where the second end segment and the second end of the elongated body are separated by a second tie, and further, where one or more of the first tie and the second tie may include one or more of a threaded tie, a fabric tie, a plastic tie, a metal tie, or a crimp.

In one aspect, the elongated body may be positionable substantially continuously around at least a portion of each of the plurality of toes.

In a further aspect, the elongated body may apply a pressure on at least a portion of each of the plurality of toes.

In still another aspect, the elongated body may be positioned between the plurality of toes such that the elongated body concurrently applies a pressure on the plurality of toes.

A toe massager in another embodiment includes an elongated body having a first end and a second end and positionable in a looping manner between a plurality of toes such that each of the plurality of toes are spaced apart from each other, where the elongated body applies a pressure on at least a portion of each of the plurality of toes, and where each adjacent toe is displaced in one or more of a horizontal direction or a vertical direction relative to each other.

A method of manufacturing a toe massager in still another embodiment includes providing a plurality of a first material in a close fitted arrangement to form a flexible elongated shape, providing a second material over the entire flexibly elongated shape formed by the plurality of the first material, and closing a first end and a second end of the flexible elongated shape to enclose the plurality of the first material by the second material, where the first material may include cotton thread, and where the second material may include satin.

The method may also include closing the first end and the second end includes tying the first end and the second end of the flexible elongated shape.

Various other modifications and alterations in the structure and method of operation of the particular embodiments will be apparent to those skilled in the art without departing from the scope and spirit of the disclosure. Although the disclosure has been described in connection with specific particular embodiments, it should be understood that the disclosure as claimed should not be unduly limited to such particular embodiments. It is intended that the following claims define the scope of the present disclosure and that structures and methods within the scope of these claims and their equivalents be covered thereby.

What is claimed is:

1. A toe massager, comprising:
an elongated body having a first end and a second end, the elongated body including an outer material and an inner material, wherein the elongated body is positionable between a plurality of toes such that each of the plurality of toes are spaced apart from each other.

2. The massager of claim 1 wherein the outer material of the elongated body includes satin, and further wherein the inner material of the elongated body includes cotton.

3. The massager of claim 1 wherein the elongated body has a length of approximately 11.5 inches.

4. The massager of claim 1 wherein the elongated body has a cross sectional diameter of approximately 0.5 inches.

5. The massager of claim 1 further including a first end segment at the first end of the elongated body and a second end segment at the second end of the elongated body.

6. The massager of claim 5 wherein the first end segment and the first end of the elongated body are separated by a first tie, and further, wherein the second end segment and the second end of the elongated body are separated by a second tie.

7. The massager of claim 6 wherein the one or more of the first tie and the second tie includes one or more of a threaded tie, a fabric tie, a plastic tie, a metal tie, or a crimp.

8. The massager of claim 1 wherein the elongated body is positionable substantially continuously around at least a portion of each of the plurality of toes.

9. The massager of claim 1 wherein the elongated body applies a pressure on at least a portion of each of the plurality of toes.

10. The massager of claim 1 wherein the elongated body is positioned between the plurality of toes such that the elongated body concurrently applies a pressure on the plurality of toes.

11. A toe massager, comprising:
an elongated body having a first end and a second end and positionable in a looping manner between a plurality of toes such that each of the plurality of toes are spaced apart from each other, wherein the elongated body applies a pressure on at least a portion of each of the plurality of toes, and wherein each adjacent toe is displaced in one or more of a horizontal direction or a vertical direction relative to each other.

12. The massager of claim 11 wherein the elongated body includes an inner material and an outer material, wherein the outer material comprises satin and the inner material comprises threaded cotton.

13. The massager of claim 11 wherein the elongated body has a length of approximately 11.5 inches.

14. The massager of claim 11 wherein the elongated body has a cross sectional diameter of approximately 0.5 inches.

15. The massager of claim 11 further including a first end segment at a first end of the elongated body and a second end segment at a second end of the elongated body.

16. The massager of claim 15 wherein the first end segment and the first end of the elongated body are separated by a first tie, and further, wherein the second end segment and the second end of the elongated body are separated by a second tie.

17. A method of manufacturing a toe massager, comprising:
providing a plurality of a first material in a close fitted arrangement to form a flexible elongated shape;
providing a second material over the entire flexibly elongated shape formed by the plurality of the first material; and
closing a first end and a second end of the flexible elongated shape to enclose the plurality of the first material by the second material.

18. The method of claim 17 wherein the first material includes cotton thread, and further, wherein the second material includes satin.

19. The method of claim 17 wherein closing the first end and the second end includes tying the first end and the second end of the flexible elongated shape.
